(19) United States
(12) Patent Application Publication
(10) Pub. No.: US 2015/0179014 A1
(43) Pub. Date: Jun. 25, 2015

(54) BANKNOTE HANDLING DEVICE

(71) Applicant: HITACHI-OMRON TERMINAL SOLUTIONS, CORP., Tokyo (JP)

(72) Inventors: Akira Nishino, Tokyo (JP); Yukihiro Mabuchi, Tokyo (JP); Takeshi Kanagawa, Tokyo (JP); Riichi Katou, Tokyo (JP)

(73) Assignee: HITACHI-OMRON TERMINAL SOLUTIONS, CORP., Tokyo (JP)

(21) Appl. No.: 14/409,369

(22) PCT Filed: Feb. 20, 2013
(86) PCT No.: PCT/JP2013/000931

§ 371 Date: Dec. 18, 2014

(30) Foreign Application Priority Data
Jun. 18, 2012 (JP) 2012-136749

(51) Int. Cl. G07D 11/00; G07D 7/00

(52) U.S. Cl. CPC G07D 11/0084; G07D 11/0006; G07D 7/0033

(57) ABSTRACT

A banknote handling device improves banknote delivery efficiency, by reading serial numbers on banknotes. The banknote handling device comprises: a banknote deposit/withdrawal unit for receiving and delivering banknotes from and to a user; the banknote discrimination unit that discriminates banknotes and is capable of reading banknote serial numbers; a control unit that controls the banknote deposit/withdrawal unit, the banknote discrimination unit, and the banknote storage unit. The control unit controls the banknote deposit/withdrawal unit, the banknote discrimination unit, and the banknote storage unit such that, if a deposit transaction with a user fails after banknotes have been deposited, banknotes having the same serial numbers as the serial numbers read by the banknote discrimination unit are fetched from the banknote storage unit and delivered to the banknote deposit/withdrawal unit.

### TECHNICAL FIELD

The present invention relates to a banknote handling device.

### INCORPORATION BY REFERENCE

This application is based upon and claims the benefit of priority from prior Japanese Patent Application No. 2012-136749, filed on Jun. 18, 2012, the entire contents of which are incorporated herein by reference.

### BACKGROUND ART

In a case where giving and receiving of money are conducted in a financial organ between a customer and a clerk in charge of the financial organ, a banknote handling device is used by the clerk in charge. In general, the banknote handling device includes a banknote deposit/withdrawal opening unit in which banknotes for deposit are set and banknotes for withdrawal are integrated, a banknote discrimination unit which determines whether a banknote for deposit or withdrawal is true or false and discriminates a denomination, a temporary storage unit which temporarily holds the banknote discriminated by the banknote discrimination unit, a plurality of banknote storage boxes which stores banknotes, and a reject box which stores banknotes judged to be reject by the banknote discrimination unit.

As the denominations and volume of cash handled in the banknote handling device increase, size shrinking of the banknote handling device, improvement of the conveyance efficiency of banknotes, and improvement of the conveyance reliability are demanded. For example, in Patent Literature 1, a banknote handling device in which a plurality of banknote storage boxes are disposed side by side in a lower part of the banknote storage device is disclosed. In this configuration, the size shrinking of the device is attempted by collecting other mechanical units in an upper part and shortening the conveyance path of banknotes.

### CITATION LIST

### Patent Literature

PATENT LITERATURE 1: JP-A-2011-81484

### SUMMARY OF INVENTION

### Technical Problem

In a configuration of the conventional banknote handling device, however, a banknote input to the device is passed through the banknote discrimination unit, then stored in a storage unit once, taken out from the temporary storage unit after a transaction is decided, passed through the banknote discrimination unit again, and conveyed to the banknote storage box. Therefore, a conveyance path becomes longer by a length of a part of the conveyance path between the banknote discrimination unit and the temporary storage unit, resulting in a lowered efficiency of banknote conveyance and a complicated conveyance mechanism.

The present invention has been made to solve the above-described problem. An object of the present invention is to simplify the banknote conveyance mechanism while improving the efficiency of banknote conveyance.

### Solution to Problem

A banknote handling device according to the present invention includes a banknote deposit/withdrawal unit for conducting giving and receiving of banknotes with a user, a banknote discrimination unit capable of discriminating the banknotes and reading serial numbers of the banknotes, a banknote storage unit for storing the banknotes, a conveyance path for conveying the banknotes input from the banknote deposit/withdrawal unit, to the banknote storage unit via the banknote discrimination unit, and a control unit for controlling the banknote deposit/withdrawal unit, the banknote discrimination unit, the banknote storage unit, and the conveyance path. In a case where a deposit transaction with the user is not settled after the banknotes are input, the control unit controls the banknote deposit/withdrawal unit, the banknote discrimination unit, the banknote storage unit, and the conveyance path to take out banknotes having same serial numbers as serial numbers read by the banknote discrimination unit and convey the banknotes taken out to the banknote deposit/withdrawal unit.

### Advantageous Effects of Invention

In the banknote handling device according to the present invention, the banknote discrimination unit can read a serial number of a banknote. Even in a case where a deposit transaction is not settled, therefore, banknotes having the same serial numbers as serial numbers read by the banknote discrimination unit can be taken out from the banknote storage unit and conveyed as far as the banknote deposit/withdrawal unit. Therefore, it is not necessary to provide the temporary storage unit in the banknote handling device. In other words, the conventional device has a configuration in which banknotes input to the device are stored in the temporary storage unit once after being passed through the banknote discrimination unit, and after decision of a transaction, the banknotes are passed through the banknote discrimination unit and conveyed to a banknote storage box again. In a banknote handling device according to an application example 1, however, the conveyance path can be shortened by a turnaround path between the banknote discrimination unit and the temporary storage unit. Therefore, it is possible to simplify the banknote conveyance mechanism while improving the efficiency of banknote conveyance.

The present invention can also be configured as invention concerning, for example, an automatic teller machine, a money changing machine, a banknote deposit/withdrawal machine, an automatic ticket selling machine, and the like including the banknote handling device, besides the configuration functioning as the above-described banknote handling device. Furthermore, the present invention can also be configured as invention of methods for controlling them.

### BRIEF DESCRIPTION OF DRAWINGS

FIG. 1 is a side sectional view showing a schematic configuration of a banknote handling device 100 according to an embodiment of the invention;

FIG. 2 is a side sectional view showing a conveyance direction of banknotes on a conveyance path in the banknote handling device 100;

FIG. 3 is an explanation diagram showing control blocks in the banknote handling device 100;

FIG. 4 is an explanation diagram showing operation in the banknote handling device 100 at the time of deposit processing;

FIG. 5 is a diagram showing an image of a collation result displayed on an operation terminal 200;

FIG. 6 is an explanation diagram showing a cancel-return operation in the banknote handling device 100 at the time of deposit; and

FIG. 7 is an explanation diagram showing operation in the banknote handling device 100 in withdrawal transaction.

### DESCRIPTION OF EMBODIMENTS

Hereafter, embodiments will be described with reference to the drawings.

### Embodiment 1

### A. Configuration of Banknote Handling Device

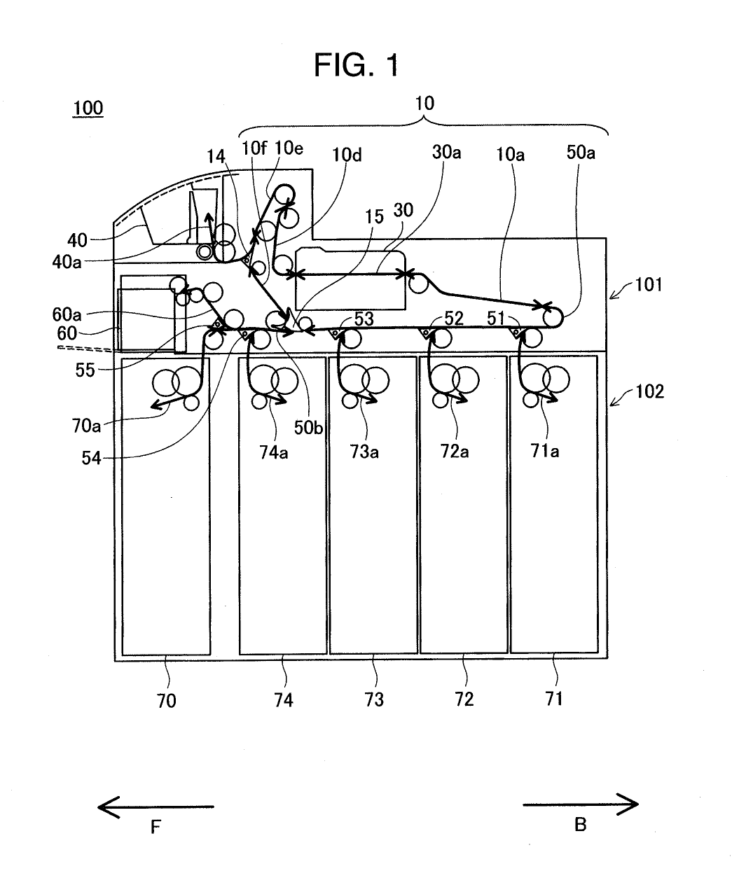

FIG. 1 is a side sectional view showing a schematic configuration of a banknote handling device 100 according to an embodiment of the present invention. The banknote handling device 100 is a device managed by a financial organ such as a bank to conduct various transactions depending upon operation of a user (a clerk in the financial organ). A processing mechanism 101 of banknotes in transaction is disposed in an upper part of the banknote handling device 100, and a storage mechanism 102 of banknotes is disposed in a lower part of the banknote handling device 100.

Mechanisms required to give/receive banknotes to/from the user are collected in the processing mechanism 101. The processing mechanism 101 includes a banknote deposit/withdrawal opening 40, a banknote discrimination unit 30, a deposit reject box 60, and a control unit 16. By the way, the control unit 16 is omitted in FIG. 1 to facilitate understanding of the technique.

The banknote deposit/withdrawal opening 40 and the banknote discrimination unit 30 are coupled to each other by conveyance paths 40a, 10e and 10d. The banknote discrimination unit 30 and the deposit reject box 60 are coupled to each other by conveyance paths 10a, 50a, 50b, and 60a. By the way, it is also possible to changeover a gate 14 and a gate 15 to couple the conveyance paths 10a and 50b with a conveyance path 10f.

In a front part of the processing mechanism 101, the banknote deposit/withdrawal opening 40 is disposed for the user to input and take out banknotes. By the way, in the present specification, “front” means a side in which the user is situated when utilizing the banknote handling device 100 (a direction indicated by an arrow F), and “rear” means a side opposite to the front (a direction indicated by an arrow B). Furthermore, “lateral direction” means a lateral direction at the time when the user stands in a direction facing from the front side to the rear side. Banknotes are input into the banknote deposit/withdrawal opening 40 by the user in a direction in which long sides of banknotes are parallel to the lateral direction and short sides of the banknotes are parallel to the forward-backward direction. The same also holds true when banknotes are ejected from within the banknote handling device 100 into the banknote deposit/withdrawal opening 40.

Banknotes passed through the conveyance paths 40a, 10e, and 10d from the banknote deposit/withdrawal opening 40 passes through a conveyance path 30a in the banknote discrimination unit 30. The banknote discrimination unit 30 discriminates (1) a denomination, (2) authenticity and (3) whether the banknote is a reject banknote with respect to each of banknotes conveyed from the conveyance path 10d or the conveyance path 10a to the banknote discrimination unit 30, and outputs results of the discrimination to the control unit 16. By the way, “reject banknote” means a banknote which should not be subject to a transaction. Here, “transaction” includes return of banknotes to the user in a case where deposit is canceled.

Furthermore, the banknote discrimination unit 30 reads a serial number unique to the banknote. The serial number is recorded in a memory 162. In other words, the banknote discrimination unit 30 can conduct denomination discrimination and authenticity discrimination on banknotes conveyed in both directions. In addition, the banknote discrimination unit 30 can manage information of banknotes stored in the device by storing serial numbers which are read in the device. Here, discrimination of banknotes can be conducted by utilizing various kinds of information such as, for example, image data obtained by scanning a banknote, an unevenness shape of a surface of a banknote, magnetic characteristics, and optical characteristics to ultraviolet rays or the like.

A banknote discriminated to be a banknote that is not subject to a deposit transaction in the banknote discrimination unit 30 is passed through the conveyance paths 10a, 50a, 50b, and 60a from the conveyance path 30a as a reject banknote and stored in the deposit reject box 60 to be returned to the user. By the way, the gate 15 is disposed in a connection portion between the conveyance path 50a and the conveyance path 50b, and a gate 55 is disposed in a connection portion between the conveyance path 50b and the conveyance path 60a.

In the storage mechanism 102, banknote storage boxes 71 to 74 which store banknotes according to the denomination and a withdrawal reject box 70 for storing banknotes that are not used in withdrawal transactions are arranged in a line from the rear side toward the front side.

The banknote storage box 71 is connected to the conveyance path 50a via a conveyance path 71a. A gate 51 is disposed in a connection portion between the conveyance path 50a and the conveyance path 71a. The banknote storage box 71 includes a mechanism that accumulates and stores banknotes conveyed from the conveyance path 71a in a vertical direction and a. mechanism that takes out stored banknotes onto the conveyance path 71a.

The banknote storage box 72 is connected to the conveyance path 50a via a conveyance path 72a. A. gate 52 is disposed in a connection portion between the conveyance path 50a and the conveyance path 72a. The banknote storage box 73 is connected to the conveyance path 50a via a conveyance path 73a. A gate 53 is disposed in a connection portion between the conveyance path 50a and the conveyance path 73a. The banknote storage box 74 is connected to the conveyance path 50b via a conveyance path 74a. A gate 54 is disposed in a connection portion between the conveyance path 50b and the conveyance path 74a. The withdrawal reject box 70 is connected to the conveyance path 50b via a conveyance path 70a. The gate 55 is disposed in a connection portion between the conveyance path 50b and the conveyance path 70a. By the way, a mechanism of each of the banknote storage boxes 72 to 74 and the withdrawal reject box 70 is similar to that of the banknote storage box 71.

As for storage of a banknote into the withdrawal reject box 70, the banknote passes through the banknote discrimination unit 30, and then the control unit 16 changes over the gates 14, 15 and 55 to connect the conveyance paths 10d, 10e, 10f, 50b and 70a and convey the banknote.

By the way, the withdrawal reject box 70 is also utilized as a loading recovery box for storing banknotes to be previously loaded in the banknote storage boxes 71 to 74 before operation of the banknote handling device and banknotes recovered from the banknote storage boxes 71 to 74 after the operation of the banknote handling device 100. The banknote handling device 100 can cope with various use modes by changing the disposition and functions of the banknote storage boxes 71 to 74 and the withdrawal reject box 70. Furthermore, in the banknote handling device 100, the banknote deposit/withdrawal opening 40 and the banknote discrimination unit 30 are disposed side by side, and the banknote storage boxes 71 to 74, the withdrawal reject box 70, and the withdrawal reject box 60 are also disposed side by side. Therefore, curved portions on the conveyance paths can be reduced, and it is possible to simplify the banknote conveyance mechanism while improving the efficiency of banknote conveyance.

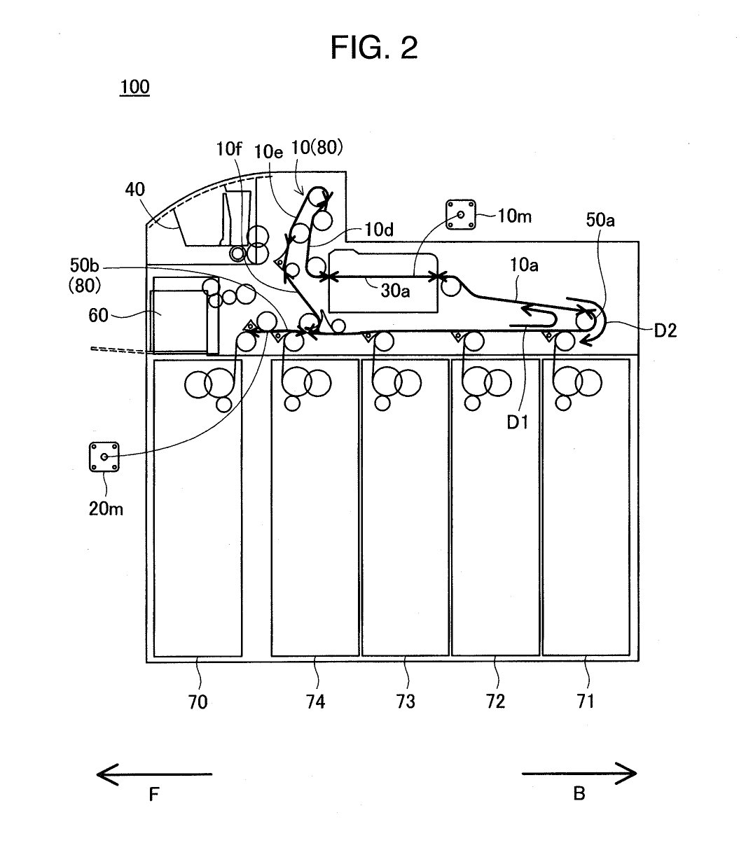

FIG. 2 is a side sectional view showing a conveyance direction of banknotes on a conveyance path 80 in the banknote handling device 100. The conveyance path 80 includes a first conveyance path 10 (50a, 10a, 30a, 10d, 10e, and 10f in FIG. 1) and the second conveyance path 50b. On the first conveyance path 10, banknotes are conveyed in both direction of a first conveyance direction D1 and a second conveyance direction D2 by using a drive motor 10m. Here, the first conveyance direction D1 means a direction proceeding from the conveyance path 50a to the conveyance path 10a without passing through the conveyance path 10f. The second conveyance direction D2 means a direction proceeding from the conveyance path 10a to the conveyance path 50a without passing through the conveyance path 10f. By the way, although the first conveyance path 10 takes the shape of a loop, banknotes are not conveyed to circulate on the first conveyance path. Furthermore, the drive motor 10m is taken out from its original position and illustrated in FIG. 2 in order to facilitate understanding of the technique.

The second conveyance path 50b nearly taking the shape of a straight line can convey banknotes in both directions of forward and backward by using a drive motor 20m. The drive motor 20m is also taken out from its original position and illustrated in the same way as the drive motor 10m in order to facilitate understanding of the technique. By the way, the first conveyance path 10 and the second conveyance path 50b include a plurality of conveyance rollers indicated by circular symbols in FIGS. 1 and 2, and include drive motors which are not illustrated to rotate those conveyance rollers in both directions, besides the drive motors 10m and 20m.

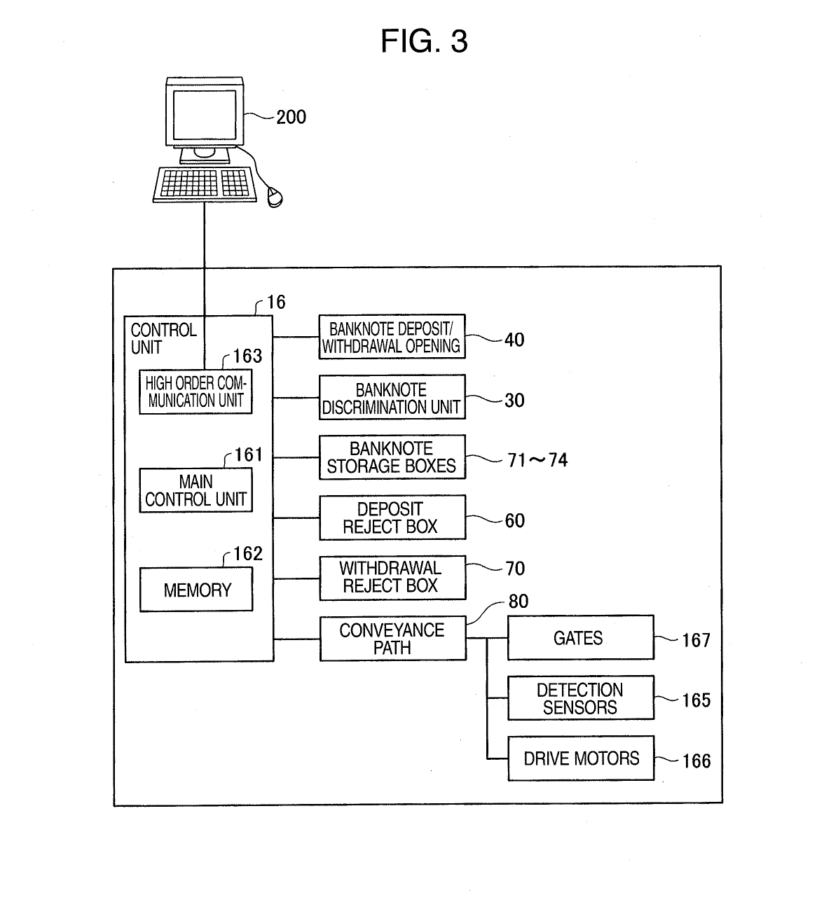

FIG. 3 is an explanation diagram showing control blocks in the banknote handling device 100, The control unit 16 includes a main control unit 161, a memory 162, and a high order communication unit 163 capable of communicating with an operation terminal 200. The main control unit 161 mainly includes a microprocessor for control. The main control unit 161 controls the banknote discrimination unit 30, the banknote deposit/withdrawal opening 40, the deposit reject box 60, the withdrawal reject box 70, the banknote storage boxes 71 to 74, and the conveyance path 80. Here, control of the conveyance path 80 exercised by the main control unit 161 is exercised by controlling detection sensors 165, drive motors 166, and gates 167. The detection sensors 165 are installed on the conveyance path 80, and in the banknote deposit/withdrawal opening 40, the deposit reject box 60, the withdrawal reject box 70, and the banknote storage boxes 71 to 74. The detection sensors 165 detect whether there is a banknote on each conveyance path and whether storage into a banknote storage box or the like is completed. By the way, illustration of the detection sensors 165 is omitted to facilitate understanding of the technique. Furthermore, the gates 167 include the gates 14, 15, 51, 52, 53, 54 and 55.

### B. Deposit Processing

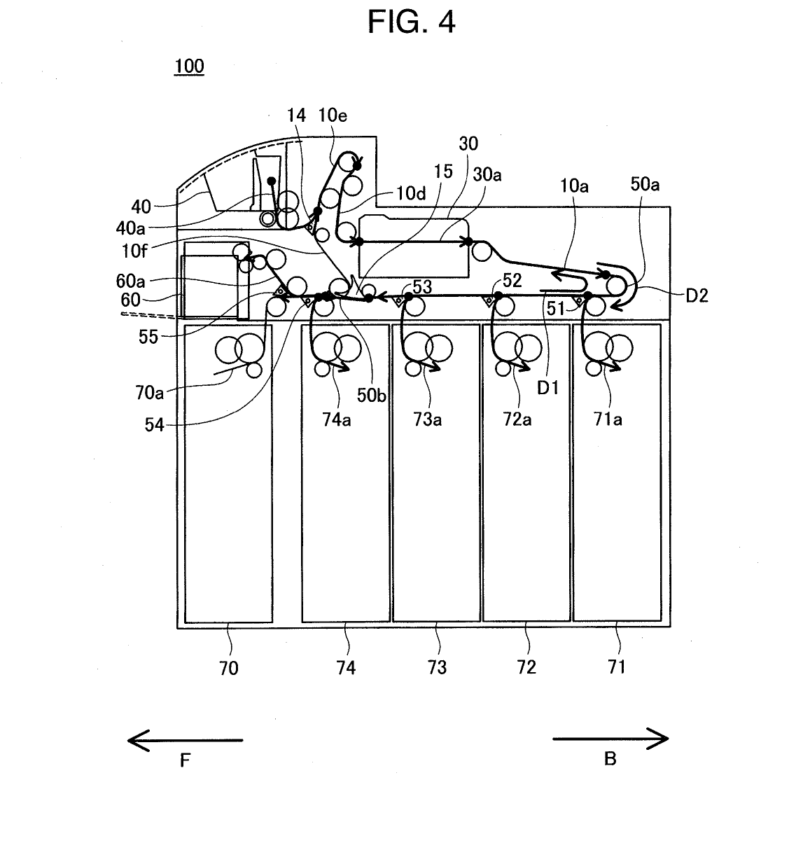

FIG. 4 is an explanation diagram showing operation in the banknote handling device 100 at the time of deposit processing. The “deposit processing” is processing of conveying banknotes input to the banknote deposit/withdrawal opening 40, to the banknote storage boxes 71 to 74 or the deposit reject box 60.

At the time of the deposit processing, the main control unit 161 controls the gate 14 to connect the conveyance path 40a to the conveyance path 10e. Furthermore, the main control unit 161 controls the gate 15 to connect the conveyance path 50a to the conveyance path 50b. And the main control unit 161 controls conveyance rollers and the like provided on respective conveyance paths to take out banknotes input to the banknote deposit/withdrawal opening 40 one by one and convey the banknotes on the conveyance paths 10e, 10d and 30a in order as indicated by arrows in FIG. 4.

A banknote conveyed onto the conveyance path 30a is discriminated by the banknote discrimination unit 30. And the main control unit 161 conveys the banknote discriminated by the banknote discrimination unit 30 on the conveyance paths 10a, 50a, and 50b, in order. The main control unit 161 controls the gates 51, 52, 53 and 54 on the basis of a result of the discrimination conducted by the banknote discrimination unit 30 to distribute banknotes conveyed from the conveyance path 30a to the conveyance paths 71a to 74a, classify the banknotes according to denomination, and store the banknotes into the banknote storage boxes 71 to 74. By the way, discrimination of a banknote conducted by the banknote discrimination unit 30 is completed during conveyance of the banknote on the conveyance path 10a. As a result, banknotes are conveyed to the banknote storage boxes 71 to 74 smoothly without stopping the conveyance of banknotes.

In a case where a reject banknote is found by the banknote discrimination unit 30 during the above-described deposit processing, the main control unit 161 exercises operation control described hereafter.

If a reject banknote is found by the banknote discrimination unit 30, the main control unit 161 controls the gate 55 to connect the conveyance path 50b to the conveyance path 60a and store the reject banknote from the conveyance path 50a into the deposit reject box 60 via the conveyance paths 50b and 60a. The banknote stored in the deposit reject box 60 can be taken out by the user. Since the deposit reject box 60 is installed in the front portion of the banknote handling device 100 in the same way as the banknote deposit/withdrawal opening 40, the user can take out the reject banknote easily.

Thereafter, the main control unit 161 stores each of banknotes conveyed in the wake of the reject banknote into the banknote storage boxes 71 to 74 or the deposit reject box 60 on the basis of a result of discrimination conducted by the banknote discrimination unit 30. If all banknotes in the banknote deposit/withdrawal opening 40 are stored into the banknote storage boxes 71 to 74 or the deposit reject box 60, the main control unit 161 finishes the deposit processing. By the way, as for “decision of deposit processing,” the deposit processing is decided by operation conducted by the user.

In this way, in the deposit storage processing, operation is conducted to convey banknotes on the first conveyance path 10 in the second conveyance direction D2 and on the second conveyance path 50b in the forward direction.

The serial number of a banknote read in the banknote discrimination unit 30 and information of a banknote storage box to store the banknote discriminated by the banknote discrimination unit 30 are stored in the memory 162 by the main control unit 161. As a result, banknotes stored in the banknote storage boxes 71 to 74 are managed accurately by the main control unit 161. Therefore, decision of the deposit processing can be made without conducting movement of banknotes from the temporary reservation unit to the banknote storage unit in the conventional banknote handling device. In the banknote handling device 100, therefore, banknotes can be managed fast and accurately as compared with the conventional banknote handling device using the temporary reservation unit.

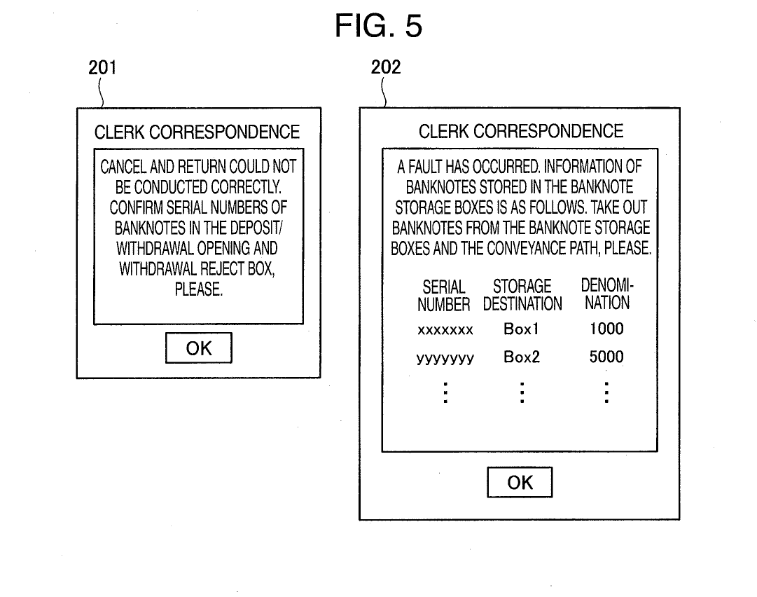

FIG. 5 is a diagram showing an image of a collation result displayed on the operation terminal 200. A serial number of each of banknotes stored in the banknote storage boxes 71 to 74 is read correctly and stored in the memory 162 when the banknote passes through the banknote discrimination unit 30. And the serial number which is read, the banknote storage box that stores the banknote, and information of the denomination are notified to the operation terminal 200 via the high order communication unit 163 by the main control unit 161. By the way, when a fault such as jamming of a banknote has occurred after passing through the banknote discrimination unit at the time of deposit, a correspondence to clerk 202 as shown in FIG. 5 is displayed on the operation terminal 200. Occurrence of a fault and information of banknotes stored in the banknote storage boxes are displayed in the correspondence to clerk 202. As a result, it becomes possible for the user to manually take out the same banknotes as deposit banknotes from the banknote handling device 100.

### C. Cancel of Deposit Processing

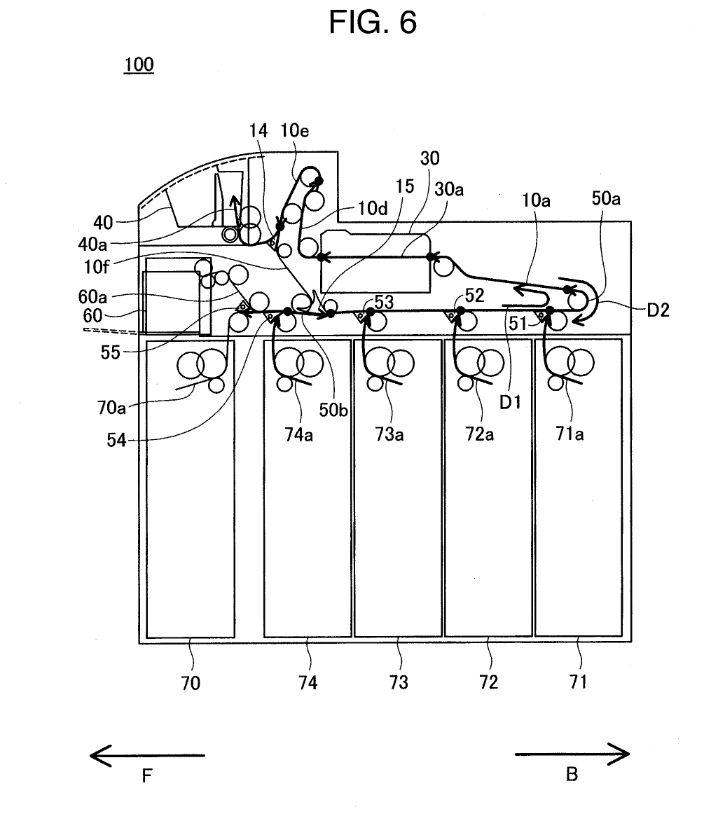

FIG. 6 is an explanation diagram showing a cancel-return operation in the banknote handling device 100 at the time of deposit. The “cancel-return” at the time of deposit means processing of returning bills input to the banknote deposit/withdrawal opening 40 and stored in the banknote storage boxes 71 to 74, from the banknote storage boxes 71 to 74 to the banknote deposit/withdrawal opening 40 because of cancel of a deposit transaction. Furthermore, “cancel of a deposit transaction” is started by a cancel operation conducted by the user after banknotes are stored into the banknote storage boxes 71 to 74.

At the time of cancel-return in the banknote handling device 100 at the time of deposit, the main control unit 161 controls the gate 15 to connect the conveyance path 50b to the conveyance path 50a. Furthermore, the main control unit 161 controls the gate 14 to connect the conveyance path 10e to the conveyance path 40a. And the main control unit 161 controls conveyance rollers and the like provided on respective conveyance paths. Furthermore, the main control unit 161 controls the conveyance paths 71a to 74a respectively corresponding to the banknote storage boxes 71 to 74 that store banknotes to be taken out, and draws out banknotes stored in the banknote storage boxes 71 to 74 onto one of the corresponding conveyance paths 71a to 74a one by one, During this time, the main control unit 161 causes the first conveyance path 10 to convey banknotes in the first conveyance direction D1 and causes the second conveyance path 50b to convey banknotes in the backward direction. By the way, banknotes to be taken out are banknotes having the same serial numbers as those stored in the memory 162 at the time of deposit. Therefore, the main control unit 161 controls respective units to take out banknotes from the same banknote storage boxes as those stored in the memory 162 at the time of deposit. This is conducted to ensure that the same banknotes as the deposited banknotes are returned.

Owing to the control exercised by the main control unit 161, banknotes taken out from the banknote storage box 74 are conveyed on the conveyance paths 50b, 50a, 10a, and 30a in order, and banknotes taken out from the banknote storage boxes 71 to 73 are conveyed on the conveyance paths 50a, 10a, and 30a in order, as indicated by arrows in FIG. 6.

A serial number of a banknote conveyed to the conveyance path 30a is read by the banknote discrimination unit 30. And the main control unit 161 conducts collation to determine whether the serial number is the same as the serial number stored in the memory 162 at the time of deposit. In a case where the serial number of a banknote conveyed to the conveyance path 30a is the same as the serial number stored in the memory 162 at the time of deposit, the main control unit 161 causes the banknote to be conveyed on the conveyance paths 10d, 10e, and 40a in order and causes the banknote to be accumulated in the bank deposit/withdrawal opening 40. By the way, during time when the banknote subject to the collation is passing through the conveyance paths 10d and 10e, collation of the banknote is completed.

The memory 162 can store 400 banknotes in a transition of one time. Data stored in the memory 162 is sent to the operation terminal 200 via the high order communication unit 163 every transaction. The data sent to the operation terminal 200 is erased from the memory 162 by the main control unit 161. In a case where the number of banknotes in a transaction exceeds 400, the transaction is divided into a plurality of times.

In a case where the main control unit 161 collates the serial number stored by the memory 162 at the time of deposit with the serial number stored by the memory 162 at the time of cancel-return and the serial numbers do not coincide with each other, the main control unit 161 gives notice to the operation terminal 200 through the high order communication unit 163. On the operation terminal 200, a correspondence to clerk 201 shown in FIG. 5 is displayed to notify the user of the collation result. Owing to the notice of the collation result, the user can confirm serial numbers of banknotes in the banknote deposit/withdrawal opening 40 and the deposit reject box 60 and find the same banknote as the deposited banknote.

Furthermore, in a case where the main control unit 161 collates the serial number stored by the memory 162 at the time of deposit with the serial number stored by the memory 162 at the time of cancel-return and the serial numbers do not coincide with each other, the main control unit 161 stops drawing out of banknotes from the banknote storage box 74 onto the conveyance path 74a once. At this time, conveyance of banknotes on each conveyance path is continued. After the detection sensor 165 has detected that all banknotes that existed on the conveyance path 70a and the conveyance path 50b are conveyed onto the conveyance path 50a and subsequent paths, the main control unit 161 changes over the gate 14 to connect the conveyance path 10e to the conveyance path 10f and changes over the gate 15 to connect the conveyance path 10f to the conveyance path 50b. Together therewith, the main control unit 161 inverts the conveyance direction of banknotes on the conveyance path 50b to the forward direction. And the main control unit 161 controls the gate 55 to store reject banknotes conveyed on the conveyance path 10d or the conveyance path 10e into the withdrawal reject box 70 from the conveyance path 70a. After the detection sensor 165 in the withdrawal reject box 70 has detected completion of conveyance or reject banknotes into the withdrawal reject box 70, the main control unit 161 inverts the conveyance direction of the conveyance path 50b to the backward direction and reopens drawing out of banknotes from the banknote storage box 74.

By the way, the case where serial numbers of a banknote do not coincide is, for example, a case where a plurality of banknotes are taken out from the banknote storage boxes 71 to 74 at a time, or a case where a banknote is conveyed to the banknote discrimination unit 30 in a state in which the direction of the banknote is oblique.

### D. Withdrawal Transaction

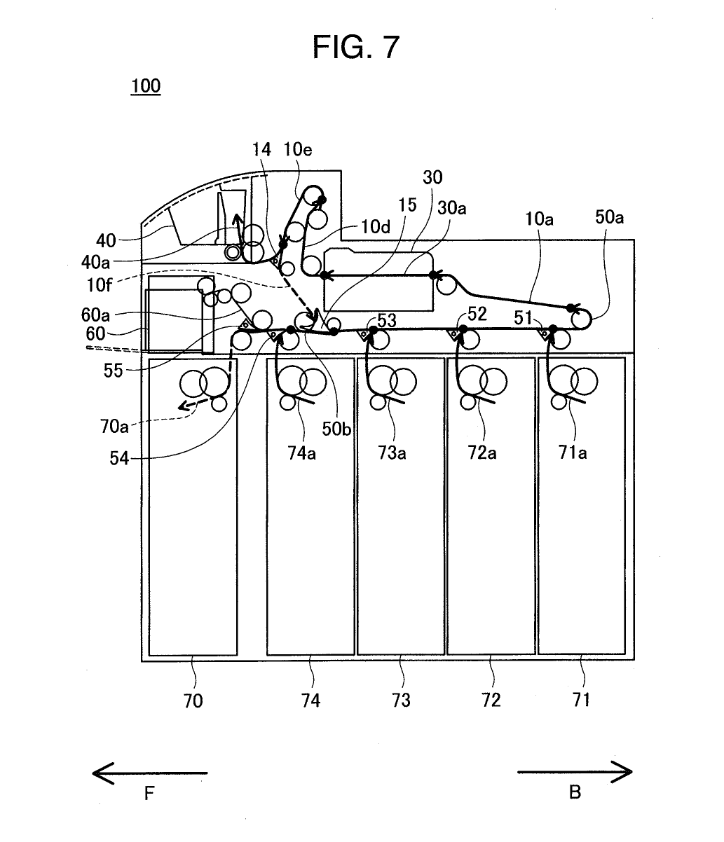

FIG. 7 is an explanation diagram showing operation in the banknote handling device 100 in withdrawal transaction. The “withdrawal transaction” is a transaction of conveying banknotes stored in the banknote storage boxes 71 to 74 to the banknote deposit/withdrawal opening 40.

At the time of the withdrawal transaction, the main control unit 161 controls the gate 15 to connect the conveyance path 50b to the conveyance path 50a. Furthermore, the main control unit 161 controls the gate 14 to connect the conveyance path 10e to the conveyance path 40a. And the main control unit 161 controls conveyance rollers and the like provided on respective conveyance paths and the conveyance paths 71 a to 74a respectively corresponding to the banknote storage boxes 71 to 74 storing banknotes to be taken out, and draws out banknotes stored in the banknote storage boxes 71 to 74 onto any one of the corresponding conveyance paths 71a to 74a one by one.

Owing to the control exercised by the main control unit 161, banknotes taken out from the banknote storage box 74 are conveyed on the conveyance paths 50b, 50a, 10a, and 30a in order, and banknotes taken out from the banknote storage boxes 71 to 73 are conveyed on the conveyance paths 50a, 10a, and 30a in order, as indicated by arrows in FIG. 7.

The main control unit 161 causes the banknote discrimination unit 30 to determine whether a banknote conveyed to the conveyance path 30a is a banknote that can be withdrawn. In a case where the banknote discrimination unit 30 has determined that the banknote is a banknote that can be withdrawn (a banknote that is not a reject banknote), the main control unit 161 causes the banknote to be conveyed on the conveyance paths 10d, 10e, and 40a in order and accumulated in the banknote deposit/withdrawal opening 40. During this time, the main control unit 161 causes the first conveyance path 10 to convey banknotes in the first conveyance direction D1 and causes the second conveyance path 50b to convey banknotes in the backward direction. By the way, during time when a banknote that is being discriminated passes through the conveyance paths 10d and 10e, discrimination of the banknote is completed.

In a case where the banknote discrimination unit 30 has determined that the banknote cannot be withdrawn, the main control unit 161 stops drawing out of banknotes from the banknote storage box 74 onto the conveyance path 74a once. At this time, conveyance of banknotes on each conveyance path is continued. After the detection sensor 165 has detected that all banknotes that existed on the conveyance path 70a and the conveyance path 50b are conveyed onto the conveyance path 50a and subsequent paths, the main control unit 161 changes over the gate 14 to connect the conveyance path 10e to the conveyance path 10f and changes over the gate 15 to connect the conveyance path 10f to the conveyance path 50b. Together therewith, the main control unit 161 inverts the conveyance direction of banknotes on the conveyance path 50b to the forward direction. And the main control unit 161 controls the gate 55 to store reject banknotes into the withdrawal reject box 70 from the conveyance path 70a. After the detection sensor 165 has detected completion of conveyance of reject banknotes into the withdrawal reject box 70, the main control unit 161 inverts the conveyance direction of the conveyance path 50b to the backward direction and reopens drawing out of banknotes from the banknote storage box 74.

By the way, “banknotes that cannot be withdrawn” means, for example, dirty banknotes, a plurality of overlapping banknotes, and banknotes that cannot be discriminated because a direction of the banknotes at the time of conveyance deviates from a direction of the banknotes at the time when stored.

Among the above-described components, the banknote deposit/withdrawal opening 40 and the conveyance path 40a correspond to the banknote deposit/withdrawal unit in “SOLUTION TO PROBLEM.” The deposit reject box 60 and the conveyance path 60a correspond to the reject banknote storage unit in “SOLUTION TO PROBLEM.” The banknote storage boxes 71 to 74, the withdrawal reject box 70, the conveyance paths 70a to 74a, and the gates 51 to 55 correspond to the banknote storage unit in “SOLUTION TO PROBLEM.” The first conveyance path 10 and the second conveyance path 50b correspond to the conveyance path in “SOLUTION TO PROBLEM.” The conveyance paths 10a, 10d, and 10e correspond to the partial conveyance unit in “SOLUTION TO PROBLEM.” The operation terminal 200 corresponds to the fault communication unit and the discrepancy notice unit in “SOLUTION TO PROBLEM.”

According to the present embodiment, the upper portion banknote processing mechanism does not have a temporary storage box unlike the conventional banknote handling device, as described heretofore. Therefore, it is possible to conduct size shrinking, simplification, and cost reduction of the banknote deposit/withdrawal device. Furthermore, it is possible to return the same banknotes as banknotes deposited at the time of deposit transaction.

### E. Modification

Heretofore, an embodiment of the present invention has been described. However, the present invention is not restricted to such an embodiment at all, but the present invention can be executed in various modes without departing from the spirit of the invention. For example, the following modifications are possible.

### E1. Modification 1

In the above-described embodiment, the number of the bank storage boxes is set to be four. However, the present invention is not restricted to this. The number of the bank storage boxes can be arbitrarily set depending upon kinds of handled banknotes.

### E2. Modification 2

In the above-described embodiment, the banknote handling device 100 includes the deposit reject box 60, the withdrawal reject box 70, and the banknote storage boxes 71 to 74 separately. However, the present invention is not restricted to this. Some banknote storage box may be also used as the deposit reject box or the withdrawal reject box.

### E3. Modification 3

In the above-described embodiment, it is described that the withdrawal reject box 70 can also be utilized as a loading recovery box for storing banknotes to be loaded in the banknote storage boxes 71 to 74 and banknotes recovered from the banknote storage boxes 71 to 74. However, the present invention is not restricted to this, but some banknote storage box may also be used as a loading recovery box. Furthermore, a loading recovery box may be provided separately.

### E4. Modification 4

In the above-described embodiment, the banknote storage box 74 is connected to the second conveyance path 50b. However, the present invention is not restricted to this. The banknote storage box 74 may be connected to the first conveyance path 10. For example, if a reject banknote has occurred at the time of withdrawal processing, in that case, it becomes unnecessary to change over the conveyance direction of banknotes on the second conveyance path 50b.

### E5. Modification 5

In the above-described embodiment, banknotes are conveyed to pass through the banknote discrimination unit 30 when conveyed from the banknote storage boxes 71 to 74 to the banknote deposit/withdrawal opening 40. However, the present invention is not limited to this. For example, the following mode is also possible. Banknotes drawn out from the banknote storage boxes 71 to 73 are conveyed on the conveyance paths 50a, 10f, and 40a in order. The banknotes drawn out from the banknote storage box 74 are conveyed on the conveyance paths 50b, 10f, and 40a in order. And the banknotes may be stored in the banknote deposit/withdrawal opening 40. In that case, banknotes that are subjected to banknote discrimination previously at the time of deposit and that need not be discriminated again can be conveyed without being passed through the banknote discrimination unit 30.

### E6. Modification 6

In the above-described embodiment, the capacity of the memory 162 is 400 banknotes. The present invention is not restricted to this. The memory may be increased or decreased depending upon a utilization mode of the banknote handling device.

### E7. Modification 7

In the above-described embodiment, the deposit reject box 60 is provided in a downstream area of the conveyance direction of the banknote storage boxes 71 to 74 at the time of deposit. However, the deposit reject box 60 may be provided in an upstream area.

### E8. Modification 8

In the above-described embodiment, the banknote deposit/withdrawal opening 40 and the deposit reject box 60 are installed in a front portion of the banknote handling device 10. However, the present invention is not restricted to this. It is also possible to provide the deposit reject box 60 in a rear portion of the banknote handling device 100 to make it possible for a person who is conducting a transaction with the user to take out the deposit reject banknotes.

### E9. Modification 9

In the above-described embodiment, the banknote storage boxes 71 to 74, the withdrawal reject box 70, and the deposit reject box 60 are disposed side by side, and the banknote deposit/withdrawal opening 40 and the banknote discrimination unit 30 are disposed side by side. However, the present invention is not restricted to this. For example, the deposit reject box 60 may be disposed between the banknote deposit/withdrawal opening 40 and the deposit reject box 60. As a result, shapes and capacities of respective units can be designed flexibly.

### E10. Modification 10

In the above-described embodiment, discrepancy between serial numbers of banknotes at the time of deposit cancel and fault occurrence at the time of deposit are displayed to the user on the operation terminal 200. However, the present invention is not restricted to this. A display screen may be provided in the banknote handling device 100 to display to the user. Furthermore, instead of the display, a notice may be given to the user by using, for example, a voice from a speaker or light from a lamp. In addition, as for the notice to the user, a notice of only the fact that the serial numbers of banknotes do not coincide or that a fault has occurred may be given.

### E11. Modification 11

In the above-described embodiment, the banknote handling device 100 includes the detection sensors 165. However, the present invention is not restricted to this. In a case where a fault has occurred at the time of deposit, information of banknotes that have passed through the banknote discrimination unit 30 at the time of deposit can be acquired even if the banknote handling device 100 does not include the detection sensors 165. Therefore, the same banknotes as the deposited banknotes can be identified.

### E12. Modification 12

In the above-described embodiment, it is described that the control unit 16 can store information such as serial numbers of banknotes obtained by the banknote discrimination unit 30 into the memory 162. However, the present invention is not restricted to this. The control unit 16 may not store information such as serial numbers of banknotes obtained by the banknote discrimination unit 30 into the memory 162. Furthermore, as to the information obtained by the banknote discrimination unit, the control unit 16 may be configured to suitably conduct information giving and receiving with the operation terminal 200 via the high order communication unit 163.

### F. Application Example

The present invention can also be implemented as application examples described hereafter.

### Application Example 1

A banknote handling device including:

a banknote deposit/withdrawal unit for conducting giving and receiving of banknotes with a user;

a banknote discrimination unit capable of discriminating the banknotes and reading serial numbers of the banknotes;

a banknote storage unit for storing the banknotes;

a conveyance path for conveying the banknotes input from the banknote deposit/withdrawal unit, to the banknote storage unit via the banknote discrimination unit; and

a control unit for controlling the banknote deposit/withdrawal unit, the banknote discrimination unit, the banknote storage unit, and the conveyance path,

in a case where a deposit transaction with the user is not settled after the banknotes are input, the control unit controlling the banknote deposit/withdrawal unit, the banknote discrimination unit, the banknote storage unit, and the conveyance path to take out banknotes having same serial numbers as serial numbers read by the banknote discrimination unit and convey the banknotes taken out to the banknote deposit/withdrawal unit.

In the banknote handling device according to application example 1, the banknote discrimination unit can read a serial number of a banknote. Even in a case where a deposit transaction is not settled, therefore, it is possible to take out a banknote having the same serial number as the serial number read by the banknote discrimination unit from the banknote storage unit and convey the banknote to the banknote deposit/withdrawal unit. Therefore, it is not necessary to provide a temporary storage unit in the banknote handling device. In other words, the conventional device has a configuration in which banknotes input to the device are stored in the temporary storage unit once after being passed through the banknote discrimination unit and conveyed to a banknote storage box through the banknote discrimination unit again after a transaction is settled. In the banknote handling device according to application example 1, however, the conveyance path can be shortened by a turnaround path between the banknote discrimination unit and the temporary storage unit. Therefore, it is possible to simplify the banknote conveyance mechanism while improving the efficiency of banknote conveyance.

By the way, in the present specification, “transaction” includes not only an act conducted among a plurality of persons in a bank or the like, but an act conducted by one person in a department store or the like. In addition, in the present specification, “banknote” is not restricted to an article issued by a nation or a central bank of a nation, but is a sheet-shaped medium issued by an organization such as a nation or an association to guarantee a value.

### Application Example 2

The banknote handling device according to application example 1, further including a reject banknote storage unit for storing reject banknotes conveyed from the banknote deposit/withdrawal, unit and discriminated to be unsuitable to a transaction by the banknote discrimination unit, wherein the reject banknote storage unit is disposed downstream the banknote storage unit on the conveyance path, and the reject banknote storage unit and the banknote deposit/withdrawal unit are disposed on same side of the banknote storage unit.

In the banknote handling device according to application example 2, the reject banknote storage unit is disposed downstream the banknote storage unit on the conveyance path. In other words, when a reject banknote is input, the banknote is passed through the banknote discrimination unit from the banknote deposit/withdrawal opening and stored in the reject banknote storage unit via the banknote storage unit. As a result, banknotes are conveyed in a determinate direction along the conveyance path. That is, it is possible to simplify the banknote conveyance mechanism while improving the efficiency of banknote conveyance.

Furthermore, the reject banknote storage unit and the banknote deposit/withdrawal unit are disposed on the same side of the banknote storage unit. In a case where a banknote is stored in the reject banknote storage unit, the user standing on the banknote deposit/withdrawal unit side can take out the reject banknote easily.

### Application Example 3

The banknote handling device according to application example 2, wherein the banknote storage unit and the reject banknote storage unit are disposed side by side, and

the banknote deposit/withdrawal unit and the banknote discrimination unit are disposed side by side

In the device according to application example 3, the banknote storage unit and the reject banknote storage unit are disposed side by side and the banknote deposit/withdrawal unit and the banknote discrimination unit are disposed side by side. As a result, curved portions on the conveyance path can be reduced. Therefore, it is possible to simplify the banknote conveyance mechanism while improving the efficiency of banknote conveyance. By the way, “the banknote storage unit and the reject banknote storage unit are disposed side by side” means that there arc not the banknote deposit/withdrawal unit and the banknote discrimination unit between the banknote storage unit and the reject banknote storage unit. Furthermore, “the banknote deposit/withdrawal unit and the banknote discrimination unit are disposed side by side” means that there are not the banknote storage unit and the reject banknote storage unit between the banknote deposit/withdrawal unit and the banknote discrimination unit.

### Application Example 4

The banknote handling device according to application example 2 or application example 3, wherein

the conveyance path can convey the banknotes in both directions along a direction in which the banknotes are conveyed, and

the conveyance path includes a partial conveyance unit for conveying banknotes passed through the banknote discrimination unit, to the banknote storage unit, the reject banknote storage unit, or the banknote deposit/withdrawal unit in a predetermined time.

The banknote handling device according to application example 4 includes a partial conveyance unit. In other words, a discrimination result is obtained during the time when a banknote exists in this portion, and smooth conveyance to a destination becomes possible without stopping banknote conveyance. As a result, it is possible to simplify the banknote conveyance mechanism while improving the efficiency of banknote conveyance. By the way, it is desirable that the partial conveyance unit passes through over the banknote storage unit.

### Application Example 5

The banknote handling device according to any one of application examples 1 to 4, including:

a discrepancy notice unit for giving a notice that there is discrepancy between serial numbers to the user,

in a case where the deposit transaction is not settled, and there is discrepancy between a serial number of a banknote taken out from the banknote storage unit for returning and a serial number of a banknote read by the banknote discrimination unit.

The banknote handling device according to application example 5 includes a discrepancy communication unit for giving a notice that there is discrepancy between serial numbers to the user, in a case where the deposit transaction is not settled, and there is discrepancy between a serial number of a banknote taken out from the banknote storage unit for returning and a serial number of a banknote read by the banknote discrimination unit. In other words, it is possible to identify the same banknote as the deposited banknote and return the banknote to the user without including the temporary storage unit by providing the discrepancy communication unit. Therefore, it is possible to simplify the banknote conveyance mechanism while improving the efficiency of banknote conveyance.

### Application Example 6

The banknote handling device according to any one of application examples 1 to 5, further including:

a detection sensor capable of detecting that a banknote passed through the banknote discrimination unit is stored in the banknote storage unit; and

a fault notice unit for giving a notice of a serial number of a banknote that is input to the banknote deposit/withdrawal unit and detected by the detection sensor, to the user, in a case where a fault has occurred at time of a deposit transaction.

In a case where a fault has occurred at the time of a deposit transaction, it is possible in the banknote handling device according to application example 6 to identify a banknote already stored in the storage unit and return the banknote to the user. By the way, since banknotes on the conveyance path are banknotes relating to this deposit transaction, the banknotes are also returned to the user. Without providing the temporary storage unit, therefore, it is possible to identify the same banknotes as deposited banknotes and return the banknotes to the user. Therefore, it is possible to simplify the banknote conveyance mechanism while improving the efficiency of banknote conveyance. By the way, “fault” includes an external fault such as a power failure besides an internal fault such as paper jamming caused by a banknote.

### REFERENCE SIGNS LIST

10: First conveyance path

10a: Conveyance path

10d: Conveyance path

10e: Conveyance path

10f: Conveyance path

10m: Drive motor

14: Gate

15: Gate

16: Control unit

20m: Drive motor

30: Banknote discrimination unit

30a: Conveyance path

40: Banknote deposit/withdrawal opening

40a: Conveyance path

50a: Conveyance path

50b: Second conveyance path

51: Gate

52: Gate

53: Gate

54: Gate

55: Gate

60: Deposit reject box

60a: Conveyance path

70: Withdrawal reject box

70a: Conveyance path

71: Banknote storage box

71a: Conveyance path

72: Banknote storage box

72a: Conveyance path

73: Banknote storage box

73a: Conveyance path

74: Banknote storage box

74a: Conveyance path

80: Conveyance path

100: Banknote handling device

101: Processing mechanism

102: Storage mechanism

161: Main control unit

162: Memory

163: High order communication unit

165: Detection sensor

166: Drive motor

167: Gate

200: Operation terminal

201: Clerk correspondence

201: Clerk correspondence

F: Arrow

B: Arrow

D1: First conveyance direction

D2: Second conveyance direction

1. A banknote handling device comprising:
a banknote deposit/withdrawal unit for conducting giving and receiving of banknotes with a user;
a banknote discrimination unit capable of discriminating the banknotes and reading serial numbers of the banknotes;
a banknote storage unit for storing the banknotes;
a conveyance path for conveying the banknotes input from the banknote deposit/withdrawal unit, to the banknote storage unit via the banknote discrimination unit; and
a control unit for controlling the banknote deposit/withdrawal unit, the banknote discrimination unit, the banknote storage unit, and the conveyance path,
in a case where a deposit transaction with the user is not settled after the banknotes are input, the control unit controlling the banknote deposit/withdrawal unit, the banknote discrimination unit, the banknote storage unit, and the conveyance path to take out banknotes having same serial numbers as serial numbers read by the banknote discrimination unit and convey the banknotes taken out to the banknote deposit/withdrawal unit.

2. The banknote handling device according to claim 1, further comprising a reject banknote storage unit for storing reject banknotes conveyed from the banknote deposit/withdrawal unit and discriminated to be unsuitable to a transaction by the banknote discrimination unit,
wherein
the reject banknote storage unit is disposed downstream the banknote storage unit on the conveyance path, and the reject banknote storage unit and the banknote deposit/withdrawal unit are disposed on same side of the banknote storage unit.

3. The banknote handling device according to claim 2, wherein
the banknote storage unit and the reject banknote storage unit are disposed side by side, and
the banknote deposit/withdrawal unit and the banknote discrimination unit are disposed side by side.

4. (canceled)

5. (Canceled)

6. (canceled)

7. The banknote handling device according to claim 2, wherein
the conveyance path can convey the banknotes in both directions along a direction in which the banknotes are conveyed, and
the conveyance path comprises a partial conveyance unit for conveying banknotes passed through the banknote discrimination unit, to the banknote storage unit, the reject banknote storage unit, or the banknote deposit/withdrawal unit in a predetermined time.

8. The banknote handling device according to claim 3, wherein
the conveyance path can convey the banknotes in both directions along a direction in which the banknotes are conveyed, and
the conveyance path comprises a partial conveyance unit for conveying banknotes passed through the banknote discrimination unit, to the banknote storage unit, the reject banknote storage unit, or the banknote deposit/withdrawal unit in a predetermined time.

9. The banknote handling device according to claim 1, comprising:
a discrepancy notice unit for giving a notice that there is discrepancy between serial numbers to the user,
in a case where the deposit transaction is not settled, and there is discrepancy between a serial number of a banknote taken out from the banknote storage unit for returning and a serial number of a banknote read by the banknote discrimination unit.

10. The banknote handling device according to claim 2, comprising:
a discrepancy notice unit for giving a notice that there is discrepancy between serial numbers to the user,
in a case where the deposit transaction is not settled, and there is discrepancy between a serial number of a banknote taken out from the banknote storage unit for returning and a serial number of a banknote read by the banknote discrimination unit.

11. The banknote handling device according to claim 3, comprising:
a discrepancy notice unit for giving a notice that there is discrepancy between serial numbers to the user,
in a case where the deposit transaction is not settled, and there is discrepancy between a serial number of a banknote taken out from the banknote storage unit for returning and a serial number of a banknote read by the banknote discrimination unit.

12. The banknote handling device according to claim 7, comprising:
a discrepancy notice unit for giving a notice that there is discrepancy between serial numbers to the user,
in a case where the deposit transaction is not settled, and there is discrepancy between a serial number of a banknote taken out from the banknote storage unit for returning and a serial number of a banknote read by the banknote discrimination unit.

13. The banknote handling device according to claim 8, comprising:
a discrepancy notice unit for giving a notice that there is discrepancy between serial numbers to the user,
in a case where the deposit transaction is not settled, and there is discrepancy between a serial number of a banknote taken out from the banknote storage unit for returning and a serial number of a banknote read by the banknote discrimination unit.

14. The banknote handling device according to claim 1, further comprising:
a detection sensor capable of detecting that a banknote passed through the banknote discrimination unit is stored in the banknote storage unit; and
a fault notice unit for giving a notice of a serial number of a banknote that is input to the banknote deposit/withdrawal unit and detected by the detection sensor, to the user, in a case where a fault has occurred at time of a deposit transaction.

15. The banknote handling device according to claim 2, further comprising:
a detection sensor capable of detecting that a banknote passed through the banknote discrimination unit is stored in the banknote storage unit; and
a fault notice unit for giving a notice of a serial number of a banknote that is input to the banknote deposit/withdrawal unit and detected by the detection sensor, to the user, in a case where a fault has occurred at time of a deposit transaction.

16. The banknote handling device according to claim 3, further comprising:
a detection sensor capable of detecting that a banknote passed through the banknote discrimination unit is stored in the banknote storage unit; and
a fault notice unit for giving a notice of a serial number of a banknote that is input to the banknote deposit/withdrawal unit and detected by the detection sensor, to the user, in a case where a fault has occurred at time of a deposit transaction.

17. The banknote handling device according to claim 7, further comprising:
a detection sensor capable of detecting that a banknote passed through the banknote discrimination unit is stored in the banknote storage unit; and
a fault notice unit for giving a notice of a serial number of a banknote that is input to the banknote deposit/withdrawal unit and detected by the detection sensor, to the user, in a case where a fault has occurred at time of a deposit transaction.

18. The banknote handling device according to claim 8, further comprising:
a detection sensor capable of detecting that a banknote passed through the banknote discrimination unit is stored in the banknote storage unit; and
a fault notice unit for giving a notice of a serial number of a banknote that is input to the banknote deposit/withdrawal unit and detected by the detection sensor, to the user, in a case where a fault has occurred at time of a deposit transaction.

19. The banknote handling device according to claim 9, further comprising:
a detection sensor capable of detecting that a banknote passed through the banknote discrimination unit is stored in the banknote storage unit; and
a fault notice unit for giving a notice of a serial number of a banknote that is input to the banknote deposit/withdrawal unit and detected by the detection sensor, to the user, in a case where a fault has occurred at time of a deposit transaction.

20. The banknote handling device according to claim 10, further comprising:
a detection sensor capable of detecting that a banknote passed through the banknote discrimination unit is stored in the banknote storage unit; and
a fault notice unit for giving a notice of a serial number of a banknote that is input to the banknote deposit/withdrawal unit and detected by the detection sensor, to the user, in a case where a fault has occurred at time of a deposit transaction.

21. The banknote handling device according to claim 11, further comprising:
a detection sensor capable of detecting that a banknote passed through the banknote discrimination unit is stored in the banknote storage unit; and
a fault notice unit for giving a notice of a serial number of a banknote that is input to the banknote deposit/withdrawal unit and detected by the detection sensor, to the user, in a case where a fault has occurred at time of a deposit transaction.
